(19) United States
(12) Patent Application Publication
(10) Pub. No.: US 2015/0025908 A1
(43) Pub. Date: Jan. 22, 2015

(54) CLUSTERING AND ANALYSIS OF ELECTRONIC MEDICAL RECORDS

(71) Applicant: HEWLETT-PACKARD DEVELOPMENT COMPANY, L.P., Houston, TX (US)

(72) Inventors: Choudur LAKSHMINARAYAN, Austin, TX (US); Shailendra K. JAIN, Palo Alto, CA (US); Wei-Nchih LEE, Palo Alto, CA (US); Pranjal MALLICK, Palo Alto, CA (US); Matthew WOOD, Palo Alto, CA (US); Matthew S. HAGEN, Palo Alto, CA (US); Karl SYLVESTER, Palo Alto, CA (US)

(73) Assignee: HEWLETT-PACKARD DEVELOPMENT COMPANY, L.P., Houston, TX (US)

(21) Appl. No.: 14/065,101

(22) Filed: Oct. 28, 2013

Related U.S. Application Data
(60) Provisional application No. 61/856,106, filed on Jul. 19, 2013.

(51) Int. Cl. G06Q 50/24; G06F 19/00

(52) U.S. Cl. CPC G06Q 50/24; G06F 19/322
USPC 705/3

(57) ABSTRACT

A technique includes clustering a plurality of electronic patient records (PRs) based on related diagnostic codes into a plurality of clusters, and analyzing one of the plurality of clusters to determine variations in resource usage within the cluster.

### BACKGROUND

Hospitals generally provide treatment and care to a multitude of patients with each patient potentially requiring a large number of clinical resources. With healthcare costs rising and the population growing older, the amount of clinical resources consumed by a typical hospital is only projected to increase. As such, monitoring and controlling those costs are becoming a focus of the healthcare industry.

### BRIEF DESCRIPTION OF THE DRAWINGS

For a detailed description of exemplary embodiments of the invention, reference will now be made to the accompanying drawings in which:

FIG. 1 is an illustrative diagram of a system for determining resource usage and treatment protocols associated with medical records in accordance with various examples;

FIG. 2A shows an example system for determining resource usage and treatment protocols in accordance with various examples;

FIG. 2B shows additional aspects of the example system for determining resource usage and treatment protocols in accordance with various examples;

FIG. 3 shows an illustrative implementation of a resource usage and treatment protocol determination system in accordance with various examples;

FIG. 4A shows a method in accordance with various examples; and

FIG. 4B shows additional method steps in accordance with various examples.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Due to the large numbers of patients treated and the services rendered, hospitals typically require a large number of clinical resources to satisfy the care of their patients. Clinical resources, in this context, include medical procedures, all types of diagnostic testing, and medications administered. As such, cost can quickly escalate due to the complexity of modern day care, especially when critically ill patients are involved, intensive care unit (ICU) patients for example. These costs are typically compounded by long hospital stays and patients that require the highest number of clinical resources per visit. Thus, hospitals have an interest in monitoring the use of these resources as part of an effort to minimize unnecessary procedures while maintaining a high level of quality of care.

With the advent and storage of electronic medical records (EMRs), a vast store of data regarding diseases, treatments, and the diagnostic data that accompany each patient is becoming available for analysis on a large scale. As used herein, an EMR may be the combination of all the patient records (PRs) retained by a medical facility, a hospital for example. Further, an EMR may also be the combination of several hospitals' EMRs. As such, an EMR may be characterized as a large database of associated medical data from different areas of a hospital, in this example. However, a hospital is used in the example due to the voluminous amounts of data typically collected, but should not be construed to limit the bounds of an EMR. This analysis may lead to a better understanding of hospital resource usage and ways to decrease resource usage while enhancing, or at least maintaining, a high level of care. The analysis involved may also be especially effective in reducing the costs of chronic or extreme illnesses that require lengthy hospital stays. As such, the data contained in the EMRs may lead to more effective critical care and a minimization in the number and types of administered procedures.

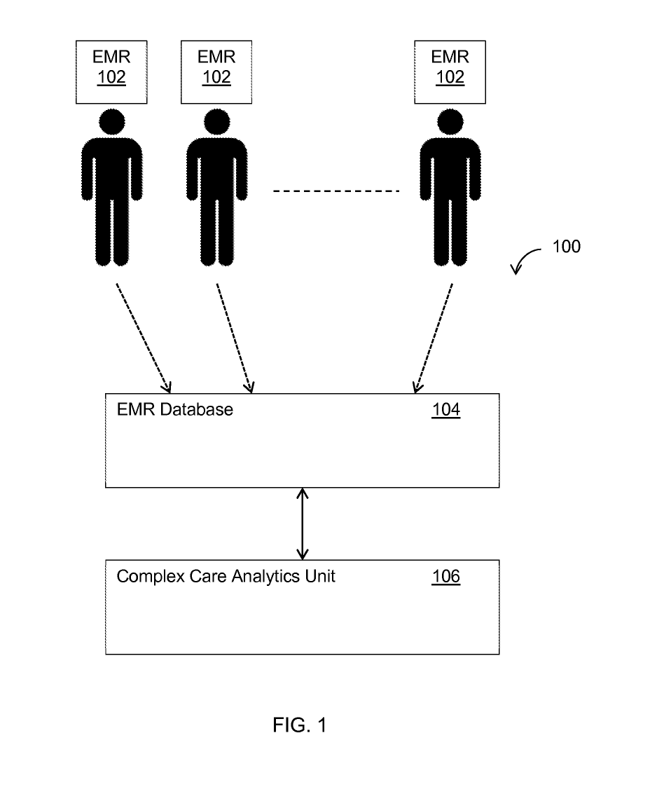

FIG. 1 is an illustrative diagram of a system 100 for determining resource usage and treatment protocols associated with medical records. The system 100 includes a plurality of patient records (PRs) 102 combined into an EMR database 104, and a complex care analytics unit 106. Each of the plurality of the EMRs 102 may be associated with a patient and may include a variety of medical information such as diagnoses associated with each doctor's visit and hospital stay. The EMR database 104 storing the plurality of PRs 102 may be a single repository associated with a medical practice group, a hospital, or a single physician. Alternatively, the EMR database 104 may be a collection of EMR databases connected via a wired or wireless network and accessible from a single or multiple entities operating the complex care analytics unit 106. Regardless of whether the EMR database 104 is a single storage device or a combination of many storage devices, the size of the EMR database 104 may be tens or hundreds of gigabytes of data, if not more. The illustrative system 100 only shows a single complex care analytics 106 unit, but there may be several such units accessing the EMR database 104 to carry out various analytics on the EMRs 102.

The individual PRs 102 may contain information regarding the associated patient's demographics and health related data since the creation of the patient's PR. The demographic data may include age, ethnicity, place of birth, occupation, and activity level, to name a few. The health-related data may include height weight, gender, and the diagnostic data, procedures administered, and treatments prescribed from every doctor's visit and hospital stay. The data and information for a single doctor's visit or hospital stay may include structured data and unstructured data.

The structured data relating the numbers and types of tests and procedures, medicines administered and how often, and heart rate, to name a few. The unstructured data may include the doctor's notes and may be in the form of diagnostic codes and other physician short-hand. For example, a patient's EMR for a hospital stay may have the following structured data: length of stay (LOS), radiology, ultrasounds, magnetic resonant imaging (MRI)/computerized tomography (CT) scan, blood bank, respiration, ventilation, diagnostic echo cardiogram (ECG), microbiology, distinct pharmacology, medicines administered, and distinct laboratory work, to name several, but this list is not exhaustive. To expound on the tests and data obtained, a physician may elaborate on the diagnosis with notes and thoughts.

Additionally, each PR 102 will have a diagnosis related group (DRG) code field and an accompanying DRG notes field. The DRG field may contain a diagnostic code related for each hospital or physicians visit which, for billing purposes mainly, will relate to the disease and treatment of the patient for a particular field. Since the DRG field is mainly used for billing purposes, the number of codes is limited. The code system used for this field may be the international code of diseases, 9^{th} edition (ICD-9). Since the number of billing codes is limited, the granularity of the codes may be somewhat lacking for defining the disease a patient may be suffering.

To add to the usefulness of the DRG codes, the ICD-9 codes may be mapped to a system that differentiates between diseases in finer detail, such as the Systematized Nomenclature of Medicine-Clinical Terms (SNOMED-CT) ontology to standardize clinical diagnosis terms associated with each patient/EMR 102. The ICD-9 codes may be more closely related to billing whereas the SNOMED-CT codes may be more closely related to the diagnoses and conditions of the patients. This diagnostic closeness, along with finer granularity, may allow subsequent analysis interpret the EMRs 102 at a higher level.

The complex care analytics unit 106 may be used to perform analytics on the vast amount of data stored in the EMR database 104. The complex care analytics unit 106 may analyze the plurality of PRs 102 stored in the EMR database 104 to determine resource usage with respect to specific or closely related diseases. This information may then be used by a physician or hospital to adjust best practices for high resource usage diseases so to reduce overall cost all while maintaining a high quality of care and minimizing unnecessary procedures.

For example, a busy hospital may apply the complex care analytics unit 106 to all patients treated in various intensive care units (e.g., pre-natal, cardiovascular, and neo-natal) for a 6-month time span (or other time span) to determine high resource usage patients and their related conditions/treatment protocols assigned. The combined data may be well over 6 gigabytes of information, which in light of the complexity of the information may be referred to as “big data.” Big data may be defined as data sets that are so large they become difficult to process. The data analyzed may contain all visits, treatments, lab tests, other diagnostics and physician's notes for each patient seen and treated in that 6-month time span. As such, amount and complexity of the resulting data set may be far too much for standard analysis.

The complex care analytics unit 106 may cluster the PRs 102 form the various ICUs into groups or clusters of closely related diseases, such as metabolic diseases or nervous system disorders, for example. The structured and unstructured data of the PRs within the clusters may then be analyzed for resource usage and treatment protocols administered. The resource usage information may come from, for example, the counts of tests performed and medicines delivered as indicated in the PRs 102. The treatment protocols administered may be extracted in a similar fashion. The complex care analytics unit 106 may then determine the variations in resource usage and their corresponding treatment protocols. That determination may then lead to the determination of the treatment protocol resulting in the lowest resource usage within a cluster of closely related patients. This mined information may then be used by the hospital to alter or update the best practices for the clusters of chronic illnesses.

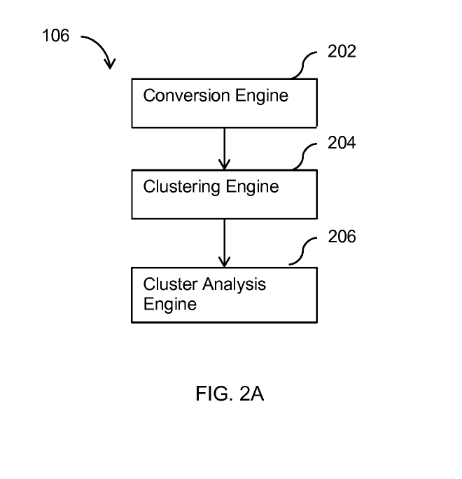

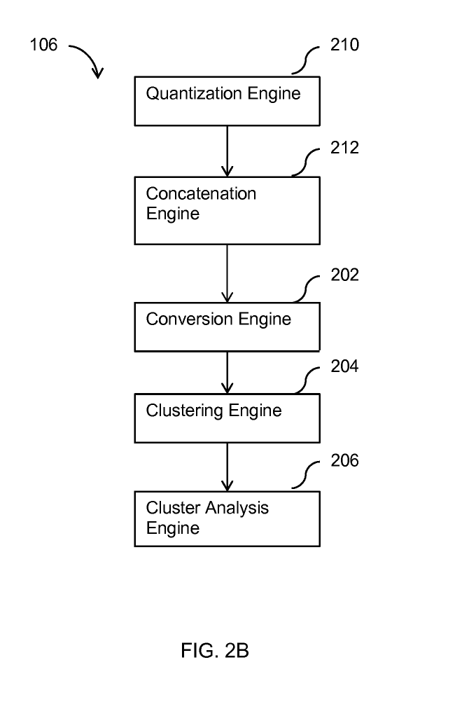

FIG. 2A illustrates an example implementation of the complex care analytics unit 106 for determining resource usage and treatment protocols. The illustrative complex care analytics unit 106 includes various engines that provide the system with the functionality described herein. The complex care analytics unit 106 may include a conversion engine 202, a clustering engine 204, and a cluster analysis engine 206. FIG. 2B illustrates some additional aspects that may be part of the example complex care analytics unit 106. The additional aspects may include a quantization engine 210 and a concatenation engine 212 and they are shown to precede the engines 202-206 of FIG. 2A. The order of the engines shown in FIG. 2B, however, are for illustration purposes only and the order may be implemented in many variations. For instance, the two engines 210 and 212 may be performed after the clustering engine 204 but before the cluster analysis engine 206.

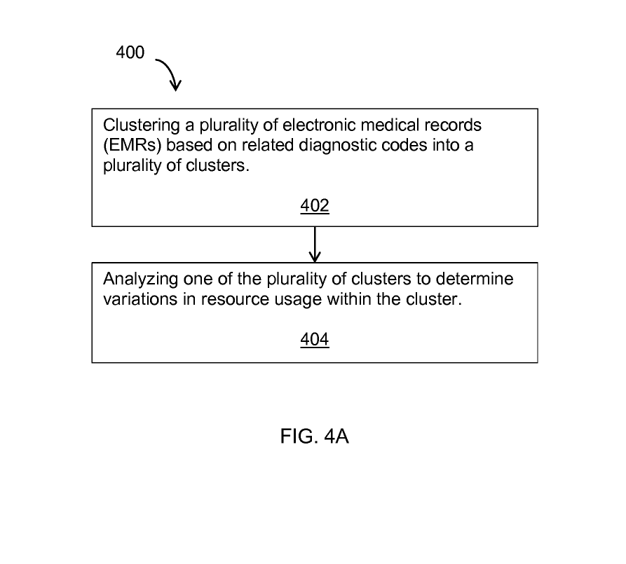

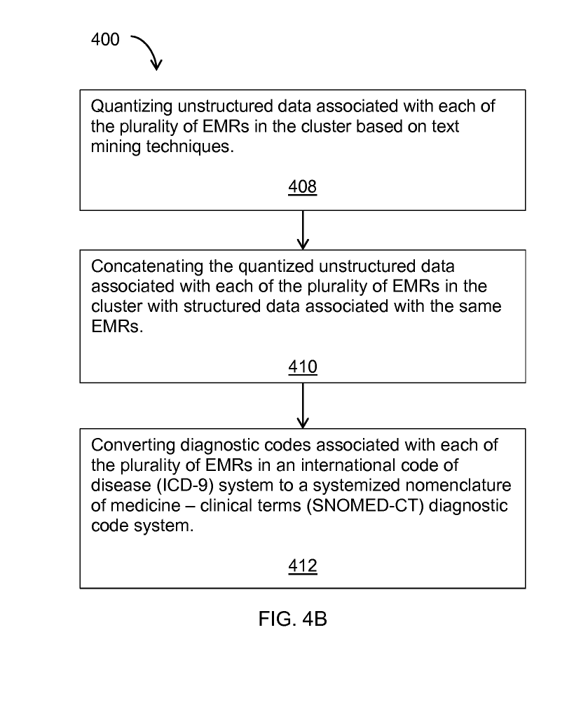

Although the various engines 202-212 are shown as separate engines in FIGS. 2A and 2B, in other implementations, the functionality of two or more or all of the engines 202-212 may be implemented as a single engine. The functionality implemented on these engines will be further explained below with regard to FIGS. 4A and 4B.

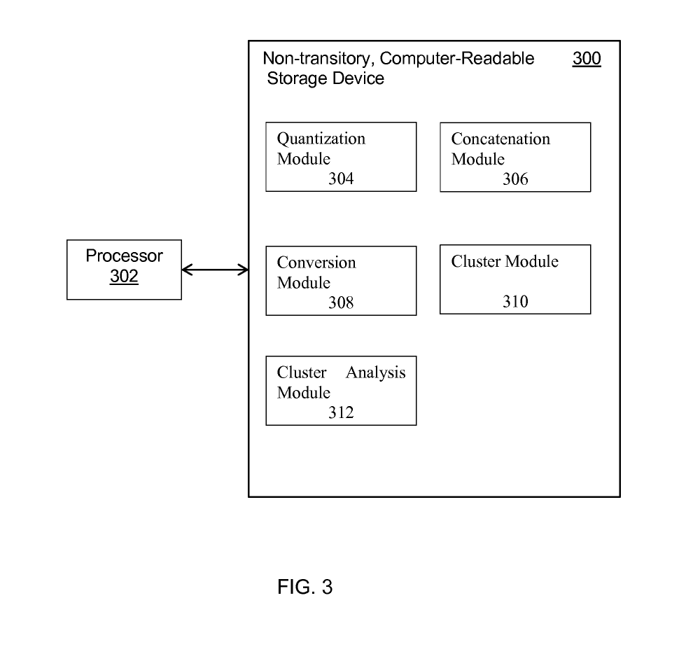

In some examples of the complex care analytics unit 106, each engine 202-212 may be implemented as a processor executing software. FIG. 3, for example, shows one suitable example in which a processor 302 is coupled to a non-transitory, computer-readable storage device 300. The non-transitory, computer-readable storage device 300 may be implemented as volatile storage (e.g., random access memory), non-volatile storage (e.g., hard disk drive, optical storage, solid-state storage, etc.) or combinations of various types of volatile and/or non-volatile storage.

The non-transitory, computer-readable storage device 300 is shown in FIG. 3 to include a software module that corresponds functionally to each of the engines of FIGS. 2A and 2B. The software modules may include a quantization module 304, a concatenation module 306, a conversion module 308, a cluster module 310, and a cluster analysis module 312. Each engine of FIGS. 2A and 2B may be implemented as the processor 302 executing the corresponding software module of FIG. 3.

The distinction among the various engines 202-212 and among the software modules 304-312 is made herein for ease of explanation. In some implementations, however, the functionality of two or more of the engines/modules may be combined together into a single engine/module. Further, the functionality described herein as being attributed to each engine 202-212 is applicable to the processor 302 executing the software module corresponding to each such engine, and the functionality described herein as being performed by a given module is applicable as well as to the corresponding engine.

The functions performed by the various engines 202-212 of FIGS. 2A and 2B and the modules 304-312 of FIG. 3 will now be described with reference to the flow diagrams of FIGS. 4A and 4B. The various operations depicted in FIGS. 4A and 4B may be performed in the order shown or in a different order and two or more of the operations may be performed in parallel instead of serially.

FIG. 4A is a method 400 for determining resource usage and treatment protocols and implements the functions of the various engines and modules discussed above. The method 400 begins at step 402 with clustering a plurality of EMRs based on related diagnostic codes into a plurality of clusters. In some implementations, this operation may be performed by the cluster module 310 of FIG. 3 by clustering groups of EMRs that have closely related diagnostic codes.

In some implementations, the cluster module 310 may apply an Ordering Points to Identify the Clustering Structure (OPTICS) algorithm to a plurality of PRs, such as the PRs 102 of FIG. 1. The OPTICS algorithm may be applied to find density-based clusters in spatial data. The OPTICS algorithm may cluster the EMRs 102 into groups or clusters based on closely related diagnostic codes based on the SNOMED-CT diagnostic codes, for example.

In terms of the OPTICS algorithm, the closeness of the diagnostic codes may be set by a threshold path length parameter. The threshold path length parameter may need to be tuned to the data because a threshold that is too large may cluster together PRs that are not related. On the other hand, a path length threshold that is too small may have create clusters of closely related diagnostic codes by the clusters may be too small to generate any useful analytical information. As such, a path length threshold of, for example, four may be selected to generate closely related clusters of statistically significant size so that further analytical analysis may produce useful information.

For example, a hospital may apply the OPTICS analysis to the PRs associated with patients seen at the hospital's various ICUs over a period of time. Regardless of what ICU the patients were seen in, the OPTICS algorithm may cluster the EMRs into clusters of closely related diseases and within a path length of four from one another. One cluster, to illustrate, may center on a cardiovascular condition associated with a specific SNOMED-CT code. The cluster may also contain patients with similar cardiovascular conditions within four SNOMED-CT codes of the center condition. Due to the hierarchical construction of the SNOMED-CT system, the cluster may contain conditions that are four path lengths above and four path lengths below the center code/disease. Other clusters may center on nervous system diseases, or renal conditions, for example. Additionally, as a check, the validity of the clusters may be reviewed by a practicing physician, board of physicians, and/or a medical record database expert to ensure treatment protocol changes are appropriate for each of the clusters.

Alternatively or additionally, a k-means clustering algorithm based on partitions may be used to generate the clusters. The k-means algorithm, however, may not be as robust as the OPTICS algorithm due to further constraints required and needing to know the number of clusters a priori.

At step 404 the method continues with analyzing one of the plurality of clusters to determine variations in resource usage within the cluster. The cluster analysis engine 206 may be used to determine the variations in resource usage by analyzing the EMRs 102 of the cluster. The EMRs 102, as discussed above, may have a set of structured data that relates to the numbers of tests performed, medications administered, and LOS. With each of these fields (e.g., one field for each test/medicine) a number of counts may be attributed that describes the number of time each test/medicine occurred. From the count data, the cluster analysis engine 206 may then calculate a total resource usage for each PR 102 in the cluster based on the cost of each test/medicine for the hospital, for example. Thus, each PR 102 in the cluster may be associated with a total resource usage, or dollar amount.

Further, the cluster analysis engine 206 may also determine groups within each cluster, or sub-clusters, based on ranges of resource usage. The sub-clusters may designate high, moderate and low resource usage patients. Prior to forming the sub-clusters, the cluster of PRs may be sorted by resource usage from high to low, or vice versa. The sorted data may show definite differences between high and low resource usage with the moderated usage falling in between. The relative differences between the three sub-cluster types (high, moderate, and low) may vary depending on disease, the hospital associated with the EMR database being analyzed, and the common practices of the institution. As such, a local domain expert may be required to empirically determine where the thresholds are for high, moderate, and low resource usage for initial analysis and then use them a predetermined values moving forward. Those predetermined values may then be used in subsequent analyses in determining resource usage sub-clusters without the aid of the domain expert. Then, based on these sub-clusters, a hospital may be able to compare the procedures administered to the different sub-clusters within a cluster to determine if any of the high resource usage patients received any unnecessary procedures. If so, the hospital may be able to limit those types of procedures for a diagnostic group to trim costs while maintaining high quality care.

FIG. 4B shows additional method steps to the method 400. At step 408, the method 400 may also include quantizing unstructured data associated with each of the plurality of EMRs in the cluster based on text mining techniques. One text mining technique that may be implemented is the term frequency-inverse document frequency (TF-IDF) technique. TF-IDF is a numerical statistic which reflects how important a word is to a document in a collection. Here the collection would be the cluster. The TF-IDF value increases proportionally to the number of times a word appears in the document, but may be offset by the frequency of the word in the collection, which may help to control for the fact that some words are generally more common than others.

Once the diagnostically significant words are extracted from the unstructured data, the method may then continue at step 404 with concatenating the quantized unstructured data associated with each of the plurality of PRs in the cluster with the structured data associated with the same PR. An PR's quantized unstructured data added to the structured data of the PR may then add to the level of analysis and clustering methods performed on the plurality of the PRs 102.

Lastly, the additional method step 412 may be performed by converting diagnostic codes in the ICD-9 system to the SNOMED-CT system. Each of the plurality of PRs 102 will have the ICD-9 code in their DRG field mapped to/converted to a corresponding code in the SNOMED-CT system. The conversion may also utilize the notes contained in the DRG note field to assist with the mapping. The note-assisted mapping may be used since one ICD-9 code may map to several different SNOMED-CT codes. The physician's notes in the DRG note filed may help further define a diagnosis in an EMR so the correct SNOMED-CT code is associated with EMR 102. Generally, the mapping/conversion may transform codes in one system to codes in a system that gives finer detail to the diseases and treatments assigned. Using codes with finer granularity may improve the clustering and subsequent analysis/treatment protocol determination.

These steps may be performed before the method steps of FIG. 4A or may be performed in various other orders. The method step 412, however, may need to be performed before the method step 402 if the plurality of EMRs 102 are not all in the same diagnostic code system, which is preferably the SNOMED-CT code system. The method steps 408 and 410 may be executed before or after the method step 402. It may be beneficial to perform steps 408 and 420 after 402 if only a small number of ensuing clusters will be fully processed to save processing time considering the large amount of data that will be processed. However, if all clusters are going to be fully analyzed, then steps 408 and 410 may be performed at any spot in the method 400. In one example, the method steps 408-412 may be performed in a sequence before performing the method steps 402,404.

The preceding discussion was seated in terms of PRs, but could also be applied to EMRs and EMR databases in general. The illustrative examples employed PRs in their description to aid the connection between the medical record and the patient. However, these same connections may be found in larger databases of EMRs. The use of the PRs to aid the description should not be seen as limiting and the analytical methods and tools may equally be applied to large EMR databases.

The above discussion is meant to be illustrative of the principles and various embodiments of the present invention. Numerous variations and modifications will become apparent to those skilled in the art once the above disclosure is fully appreciated. For example, another clustering technique may be implemented when forming the plurality of clusters out of the plurality of EMRs. It is intended that the following claims be interpreted to embrace all such variations and modifications.

What is claimed is:

1. A method, comprising:
clustering, by a processor, a plurality of electronic patient records (PRs) based on related diagnostic codes into a plurality of clusters; and
analyzing, by the processor, one of the plurality of clusters to determine variations in resource usage within the cluster.

2. The method of claim 1, further comprising quantizing, by the processor, unstructured data associated with each of the plurality of PRs in the cluster based on text mining techniques.

3. The method of claim 1, further comprising concatenating, by the processor, the quantized unstructured data associated with each of the plurality of PRs in the cluster with structured data associated with the same PRs.

4. The method of claim 1, further comprising converting, by the processor, diagnostic codes associated with each of the plurality of PRs in an international code of disease (ICD) system to a systemized nomenclature of medicine-clinical terms (SNOMED-CT) diagnostic code system.

5. The method of claim 1, further comprising determines, by the processor, a high resource usage sub-cluster within one of the plurality of clusters.

6. The method of claim 1, wherein the clustering of the PRs is based on an Ordering Points to Identify the Clustering Structure (OPTICS) algorithm.

7. The method of claim 6, wherein the clusters are based on diagnostic codes within a threshold path length.

8. A non-transitory, computer-readable storage device (CRSD) containing software that, when executed by a processor, causes the processor to:
cluster a plurality of electronic patient records (PRs) based on related diagnostic codes into a plurality of clusters;
quantize unstructured data associated with each of the plurality of PRs;
concatenate the quantized unstructured data with structured data associated with each of the plurality of PRs; and
analyze one of the plurality of clusters to determine variations in resource usage, wherein the concatenated data is analyzed.

9. The CRSD of claim 8, wherein the software causes the processor to determine a plurality of sub-clusters within one of the plurality of clusters, wherein there is a high resource usage sub-cluster, a moderate resource usage sub-cluster, and a low resource usage sub-cluster.

10. The CRSD of claim 8, wherein the software causes the processor to map diagnostic codes associated with each of the plurality of PRs in an international code of disease (ICD) system to a systemized nomenclature of medicine-clinical terms (SNOMED-CT) diagnostic code system.

11. The CRSD of claim 8, wherein the plurality of clusters are formed using a k-means algorithm.

12. The CRSD of claim 8, wherein the plurality of clusters are formed using an Ordering Points to Identify the Clustering Structure (OPTICS) algorithm.

13. The CRSD of claim 12, wherein the related diagnostic codes are within a threshold path length of one another.

14. The CRSD of claim 8, wherein the software causes the processor to determine a resource usage and the treatment protocol associated with each EMR within the cluster.

15. A system, comprising:
a conversion engine to convert diagnostic codes associated with a plurality of electronic patient records (PRs) that are in international code of diseases (IDC) system to diagnostic codes in a systemized nomenclature of medicine-clinical terms (SNOMED-CT) system;
a clustering engine to cluster the plurality of PRs into a plurality of clusters based on related diagnostic codes; and
a cluster analysis engine to analyze one of the plurality of clusters for variations in resource usage within the cluster, wherein a high resource usage sub-cluster is identified.

16. The system of claim 15, wherein the clustering of the plurality of PRs is performed using an Ordering Points to Identify the Clustering Structure (OPTICS) algorithm.

17. The system of claim 16, wherein the OPTICS algorithm clusters the plurality of PRs based on diagnostic codes within a threshold path length.

18. The system of claim 15, further comprising a quantization engine to quantize unstructured data associated with the plurality of PRs using a text mining technique.

19. The system of claim 15, further comprising a concatenation engine to concatenate the quantized unstructured data associated with each of the plurality of PRs with structured data associated with each of the plurality of PRs.

20. The system of claim 15, wherein each of the plurality of PRs contains structured data that includes at least lab tests, heart rate, respiration rate, and medications received and the unstructured data includes at least physician notes.
